(19) United States
(12) Patent Application Publication
(10) Pub. No.: US 2018/0282836 A1
(43) Pub. Date: Oct. 4, 2018

(54) METHOD FOR CONTROLLING A METALLURGICAL PLANT IN AN OPEN-LOOP AND/OR CLOSED-LOOP MANNER

(71) Applicant: SMS GROUP GMBH, Dusseldorf (DE)

(72) Inventors: Tamara GUSAROVA, Erkelenz (DE); Stephan SCHULZE, Meerbusch (DE); Ingo SCHUSTER, Willich (DE)

(21) Appl. No.: 15/525,252

(22) PCT Filed: Oct. 23, 2015
(86) PCT No.: PCT/EP2015/074682

§ 371 Date: Jun. 13, 2017

(30) Foreign Application Priority Data
Nov. 7, 2014 (DE) 10 2014 222 827.1

(51) Int. Cl. C21D 11/00; C21D 8/02; G01N 29/44; B21B 37/74; B21B 1/22

(52) U.S. Cl. CPC C21D 11/00; C21D 8/02; G01N 29/11; B21B 37/74; B21B 1/22; G01N 29/4454

(57) ABSTRACT

A method for controlling a metallurgical plant in an open-loop and/or closed-loop manner. In order to enable simple, robust, and economical open-loop and/or closed-loop control of a metallurgical plant, the method includes the following steps: detecting a metal microstructure of a metal product after the performance of a processing step on the metal product by the plant; producing at least one microstructure characterization that characterizes the detected metal microstructure; comparing the produced microstructure characterization with at least one specified limit criterion; and performing a further processing step, which follows the processing step, on the metal product by the plant only if the produced microstructure characterization meets the specified limit criterion.

The invention relates to a method of and a system for controlling and/or regulating a metallurgical plant.

The invention also relates to a computer program, a data carrier and a computer system.

Due to advances in technology and engineering ever greater demands are being placed on the types of steel used in each case. In order to meet these demands, calculation models are used in steel manufacturing which allow highly technological processes, such as the rolling of metal products, to run in accordance with particular predefined plans in order to considerably improve the mechanical properties of a finished end product. During this the start and end points of individual process stages depend decisively on the microstructural changes taking place in the material to be processed.

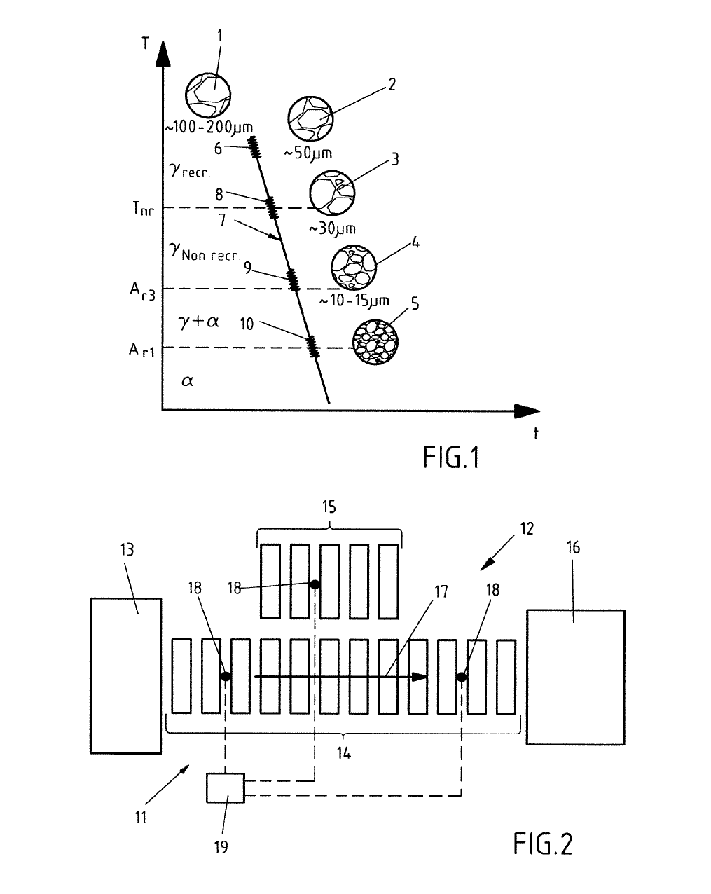

The microstructural changes taking place in a material to be processed are shown as an example by way of FIG. 1 which illustrates by way of example a thermomechanical rolling process of a steel plate and the microstructural changes associated therewith.

The rolling process shown in FIG. 1 takes place in several phases, between which a slab, previously reheated in a furnace, must cool down. After a first rolling phase or a first thermomechanical rolling process at high temperatures the metal micro-structure/the austenite recrystallizes. Rapid grain coarsening then takes place. This first rolling phase is usually used for shaping. After a subsequent further rolling phase/a further thermomechanical rolling process at lower temperatures the metal micro-structure/the austenite recrystallizes to a finer grain. Subsequent grain coarsening is strongly slowed down due to the lower temperatures.

The decisive forming process takes place in a temperature range between the temperatures Tₙᵣ and Aᵣ₃. Here, Tₙᵣ is the temperature below which recrystallization is strongly retarded and Aᵣ₃ the temperature at which the formation of ferrite starts. As in this temperature range the material can no longer dynamically recrystallize, the deforming effect of several roll passes can be accumulated without the metal microstructure recovering. Strongly elongated and “pancake-like” rolled austenite grains are produced which have many seeds for ferrite formation (also known as “pancaking”). During the subsequent cooling to below the temperature Aᵣ₃ an extremely fine ferrite metal microstructure is therefore formed.

The temperature range between the temperatures Tₙᵣ and Aᵣ₃ is relatively small. In order to be able to reliably attain this temperature range during thermomechanical rolling, it can, in a conventional manner, be expanded through additional alloying, for example, of niobium. The large selection of different alloying elements which influence the temperature range between the temperatures Tₙᵣ and Aᵣ₃ and normally occurring fluctuations in the process do not allow the exact determination of times of structural changes and thereby bring about sometimes great uncertainties in the adjusting of the mechanical properties of the finished end product.

The same also applies to the temperature range below the temperature Aᵣ₃. In multiphasic rolling processes partial crystallization of the austenite being held between individual rolling phases to form a microstructure with mixed grain sizes must be avoided. Such an unwanted mixed microstructure can no longer be fully eliminated in the following rolling phases and results in low ductile properties in the finished end product. Furthermore, rolling in this low temperature range can lead to a coarse ferrite grain with poor breakage behavior as ferrite recrystallizes at relatively low temperatures. The effect of thermomechanical treatment of a rolled product would be nullified thereby. For this reason, and in the event that consolidation rolling with ferrite deformation (also known as “strength increasing cold deformation”) is required, the lowest permissible rolling temperature is conventionally determined through the edge temperature of the metal product.

Often, subsequent to a multiphasic rolling process, for further grain refinement and to produce strength increasing microstructural phases, such as bainite and martensite for example, accelerated cooling of the rolling product takes place. Here it is just as important to hit the starting point of cooling precisely, wherein cooling should best begin exactly after one hundred percent recrystallization, even before the austenite grain begins to grow again.

From the above it follows that precise measurement of the start and end points of such microstructural changes, such as recrystallization and conversion, as well as of proportions of the corresponding not yet changed or already changed microstructures, such as residual austenite, and possibly also of grain sizes is of outstanding importance for optimization of the rolling process.

From WO 2004/050923 A1 a method of process control or process regulation of a metallurgical plant for forming, cooling and/or thermal treatment is known which is based on a process model. Recorded online is a value meaningful for the metal microstructure of the metal product to be processed, by way of which a dynamic on-line adaption of the process model, for example the pass schedule or the cooling section model, is carried out.

The aim of the present invention is to make simple, robust and cost-effective control and/or regulation of a metallurgical plant possible.

This aim is achieved through the independent claims. Advantageous embodiments are, in particular, set out in the dependent claims, which can each per se or in various combinations with each other constitute an aspect of the invention.

The method according to the invention of controlling and/or regulating a metallurgical plant comprises the steps:
recording a metal microstructure of a metal product after carrying out a processing step on the metal product by means of the plant;
producing at least one microstructure characterization characterizing the respectively recorded metal microstructure;
comparing the respectively produced microstructure characterization with at least one predetermined limit criterion; and
carrying out a further processing step following the processing step on the metal product by means of the plant only if the respectively produced microstructure characterization meets the predetermined limit criterion.

According to the invention a metal product to be processed is only supplied to a further processing step if the metal microstructure of the metal product is optimal for carrying out the further processing step, or taking into consideration, in particular firmly, specified parameters of the further method step leads to desired properties of the metal product after carrying out the further processing step. Thus, unlike in the case of WO 2004/050923 A1, it is not necessary to adapt a process model dynamically online to the available metal microstructure. According to the invention therefore no subsequent correction of a process model has to be carried out. Instead, a given process model can be retained unchanged. Theoretically rolling could be carried out. entirely without a process model. Through this, in comparison to WO 2004/050923 A1 considerably simpler, more robust and more cost-effective control and/or regulation of a metallurgical plant can take place.

The method according to the invention can, for example, be used when rolling a heavy plate of an exacting type of steel. After rolling the plate can be stopped before cooling to wait the time the material requires to be able to convert completely. Usually such a waiting time is pre-calculated by way of an existing process model as generally no measuring devices or measuring methods are available. Conventional calculation of the waiting times by way of existing process models is not always accurate and as a rule has to be adjusted to the relevant material of the metal product through dynamic adaptation. Errors in the advance calculation of conversion processes would in this case lead to an undesirable combination of properties of the finished metal product. In contrast to this the method according to the invention allows precise determination of the conversion time interval as well as of the converted portion of the microstructure. The further processing steps can thus be started at the correct or optimum time without dynamic adaptation of the models forming the basis of the processing steps being necessary. This results in essential optimization of the properties of the finished end products as well as in more stable production.

The invention is particularly advantageous in the processing of relatively short plates, for example when their length is shorter than the cooling section used for cooling. In such cases conventional changing of the cooling section parameters is not desirable and not expedient.

The recording of the metal microstructure of the metal product after carrying out a processing step on the metal product by means of the plant can take place using one, two or more recording devices. The recording of the metal microstructure is not restricted to a special recording method. The recording of the metal microstructure can also be used to check process models and to increase their meaningfulness To record the metal microstructure, parameters such as time of start of conversion, time of end of conversion, a residual austenite portion, a grain size, a texture or suchlike can be recorded.

The microstructure characterization can be a single value, a combination of values, a function or another microstructure characterization characterizing the metal microstructure. Two or more different micro-structure characterizations can also be produced for one recorded metal microstructure.

In accordance with the microstructure characterization the limit criterion can be a single value, a combination of values, a function or suchlike. For example the limit criterion can be fulfilled by not reaching or by exceeding a limit criterion in the form of a limit value. Alternatively the limit criterion can be fulfilled by an identity or a predetermined degree of similarity between the microstructure characterization and the limit criterion. The limit criterion can be predetermined off-line or can be pre-calculated.

By comparing the respectively produced microstructure characterization the predetermined limit criterion it can be determined whether the microstructure characterization will meet the predetermined limit criterion and whether the metal product can be supplied to the further processing step.

The metal product can a slab, a plate or suchlike. A processing step can be performed, for example, by rolling, cooling or heating.

Through the recording of the metal microstructure of the metal product at various times, checking/optimization of a predetermined calculation model which is normally used for treating and processing metal products is possible. In particular it can be checked whether a treatment start time of such a calculation model has been optimally selected. If not, the calculation model can be corrected or optimized.

According to an advantageous embodiment the recording of the metal microstructure takes place continuously or at predetermined time intervals until the respectively produced microstructure characterization meets the pre-determined limit criterion. This allows monitoring of the metal microstructure until this exhibits an optimum state for the further processing step. Compared with continuous recording of the metal microstructure, repeated recording of the metal microstructure at predetermined time intervals is associated with reduced data processing. The time intervals can be matched to the particular application. In particular, the time intervals over a corresponding recording cycle can remain constant or be changed, for example shortened.

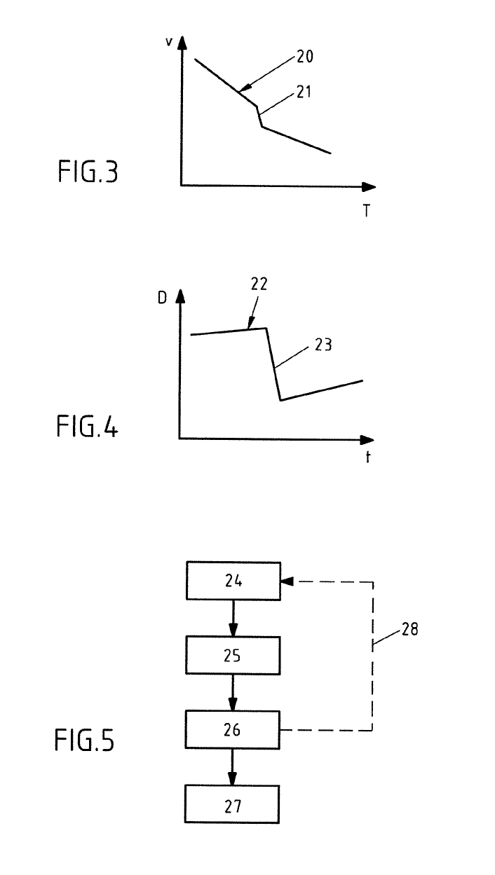

According to a further advantageous embodiment the recording of the metal microstructure takes place using ultrasound. Appropriate contact-less ultrasound recording can be used for example, in contrast to recording using a measurement of residual magnetization of the metal product at any product thickness, for example up to several hundred millimeters. For ultra-sound recording at least one electromagnetic ultrasound transducer (EMAT) or a laser ultrasound method (LUS) can be used. A change in the metal microstructure taking place in the metal product can be recorded in the timing and amplitudes of the ultrasound signal as microstructure refinement during recrystallization and a crystal lattice change during conversion cause corresponding changes in the course of the ultrasonic speed and ultrasound attenuation as is indicated in FIGS. 3 and 4. The volumetric proportion of the converted micro-structure portion can also be determined from the ultrasound signal. Determination of the grain size is also possible with ultrasound.

A further advantageous embodiment envisages that at least one further parameter of the metal product is recorded. For example, the temperature of the metal product, the thickness of the metal product or suchlike can be recorded. Through considering at least one further parameter of the metal product the precision of the produced microstructure characterization can be increased.

The computer program according to the invention comprises program code means stored on a computer-readable data carrier which cause a computer or a corresponding calculation unit to implement a method according to any one of the aforementioned embodiments or any combination thereof when they are run on the computer or the corresponding calculation unit. The advantages cited above in relation to the method are accordingly associated with the computer program.

The data carrier according to the invention comprises an aforementioned computer program. The advantages cited above in relation to the method are accordingly associated with the data carrier.

Loaded on the computer system according to the invention is an aforementioned computer program. The advantages cited above in relation to the method are accordingly associated with the computer system.

The system according to the invention for controlling and/or regulating a metallurgical plant comprises
at least one recording device for recording a metal microstructure of a metal product after carrying out a processing step on the metal product by means of the plant and
at least one control and/or regulating device, connectable in communication terms to the recording device, for producing at least one microstructure characterization characterizing the respectively recorded metal microstructure,
wherein the control and/or regulating device is set up to compare the respectively produced micro-structure characterization with at least one predetermined limit criterion; and
wherein the control and/or regulating device is set up to control and/or regulate the plant in such a way that a further processing step following the processing step is carried out on the metal product by means of the plant only if the respectively produced microstructure characterization meets the predetermined limit criterion.

The advantages cited above with. reference to the method are accordingly associated with the system. The recording device can be arranged before or after a roller stand, in a roller table, on a shunt (“shuttle”) or in a cooling section of the metallurgical plant. The system can also comprise two or more, identically or differently designed recording devices which are arranged at various positions of the metallurgical plant. The control and/or regulating device can be formed by a plant control or regulating device or be arranged separately therefrom. For comparing the microstructure characterization with the limit criterion the control and/or regulation device can comprise a calculation unit with evaluation software and a memory unit with the predetermined limit criterion. An existing metallurgical plant can be retrofitted with the system.

An advantageous embodiment envisages that the recording device and the control and/or regulating device are set up to carry out the recording of the metal microstructure continuously or at predetermined time intervals until the respectively produced microstructure characterization meets the predetermined limit criterion. This embodiment is accordingly associated with the advantages associated above with reference to the corresponding embodiment of the method.

According to a further advantageous embodiment the recording device comprises at least one ultrasound sensor, in particular an electromagnetic ultrasound sensor (EMAT, EMUS). This embodiment is accordingly associated with the advantages associated above with reference to the corresponding embodiment of the method.

Advantageously the recording device is set up to implement a laser-ultrasound method.

According to a further advantageous embodiment the system comprises at least one sensor unit, connectable in communication terms to the control and/or regulating device, for recording at least one further parameter of the metal product. Associated with this embodiment are the advantages cited above with reference to the corresponding embodiment of the method. The sensor unit can, for example, be designed as a pyrometer or suchlike.

Below, the invention is explained as an example by way of preferred examples of embodiment with reference to the attached figures whereby the features set out below can represent an aspect of the invention either per se or in various combinations with each other.

FIG. 1 shows a diagram of an example of a thermo-mechanical rolling process,

FIG. 2 shows a schematic view of an example of embodiment of a system according to the invention,

FIG. 3 shows a diagram of the change of the ultrasonic speed with change of temperature,

FIG. 4 shows a diagram change of the ultrasound attenuation over time and

FIG. 5 shows a schematic view of an example of embodiment of a method according to the invention.

FIG. 1 shows a diagram of an example of a multiphasic thermomechanical roiling process. In FIG. 1 five partial views 1 to 5 are shown in relation to the metal microstructure present at different temperatures and times. Partial view 1 shows a metal microstructure as can be present after reheating of a steel plate. Present in the metal microstructure is austenite (γ-iron) with a grain size of around 100 to 200 μm. After carrying out thermomechanical rolling procedure at high temperatures above the temperature Tₙᵣ as indicated by the meandering section 6 of curve 7, the austenite recrystallizes. According to partial view 2 the metal microstructure then contains austenite with a grain size of around 50 μm. After carrying out a further thermomechanical rolling process at lower temperatures around temperature Tₙᵣ as indicated by the meandering section 8 of curve 7 the austenite or metal microstructure recrystallizes to a fine grain with grain size of around 30 μm as shown in partial view 3. After carrying out a further thermomechanical rolling process at even lower temperatures around temperature Aᵣ₃ indicated by the meandering section 9 of curve 7, “pancake-like” rolled out austenite grains are formed as shown in partial view 4 which have many seeds for α-ferrite formation. Here the grain size is in a range of around 10 to 15 μm. After carrying out a further thermomechanical rolling process at even lower temperatures around temperature Aᵣ₁ as indicated by the meandering section 10 of curve 7 an even finer grain is produced in the metal microstructure as shown in partial view 5. Above the temperature Tₙᵣ recrystallization of the austenite takes place, Between the temperatures Aᵣ₃ and Tₙᵣ the recrystallization of the austenite is sharply retarded which counters coarsening of the grain. Between the temperatures Aᵣ₁ and Aᵣ₃ a mixture of austenite and α-ferrite is present. Below the temperature Aᵣ₁ only α-ferrite is still present in the metal microstructure.

FIG. 2 shows a schematic view of an example of embodiment of a system 11 according to the invention for controlling and/or regulating a metallurgical plant 12. Of the metallurgical plant 12 a roller stand 13, a roller table 14, a shunt 15 and a cooling section 16 are shown. The direction of movement of a metal product to be processed, which is not shown, is indicated by the arrow 17.

The system 11 comprises at least one recording device 18 for recording a metal microstructure of the metal product after carrying out a processing step on the metal product by means of the roller stand 13 of the plant 12. In FIG. 2 three possible positions are shown at each of which a recording device 18 can be arranged. Also, only one recording device 18 can be present arranged at one of the shown positions.

The system 11 also comprises a control and/or regulating device 19, connected in communication terms to the at least one recording device 18, for producing at least one microstructure characterization characterizing the respectively recorded metal microstructure. The control and/or regulating device 19 is set up to compare the respectively produced microstructure characterization with at least one predetermined limit criterion. The control and/or regulating device 19 is also set up to control and/or regulate the plant 12 in such a way that a further processing step following the processing step carried out with the roller stand 13 is carried out on the metal product by means of the cooling section 16 of the plant 12 only if the respectively produced microstructure characterization meets the predetermined limit criterion.

The at least one recording device 18 and the control and/or regulating device 19 are set up to carry out the recording of the metal microstructure continuously or at predetermined time intervals until the respectively produced micro-structure characterization meets the predetermined limit criterion. The recording device 18 comprises at last one ultrasound sensor, which is not shown, and can be set up to implement a laser-ultrasound method.

FIG. 3 shows a diagram of the change of the ultrasonic speed v with change of temperature, wherein the speed v of the ultrasound is plotted against the temperature T. The curve 20 shows the dependency of the speed v on the temperature T, wherein the speed v increases with decreasing temperature T. The curve 20 comprises a section 21 which relates to the conversion of the austenite to α-ferrite.

FIG. 4 shows a diagram of the change of the ultrasound attenuation D over time t. The curve 22 shows the dependency of the attenuation D on the time t. The curve 22 contains a section 23 which relates to the decrease in attenuation D during the recrystallization of the austenite and the associated grain refinement.

FIG. 5 shows a schematic view of an example of embodiment of a method according to the invention of controlling and/or regulating a metallurgical plant. In step 24 a metal microstructure of a metal product after carrying out a processing step on the metal product by means of the plant is recorded. In step 25 from the respectively recorded metal microstructure at least one microstructure characterization characterizing the respectively recorded metal microstructure is produced. In step 26 the respectively produced microstructure characterization is compared with at least one predetermined limit criterion. If the respectively produced microstructure characterization meets the predetermined limit criterion a further processing step 27 following the processing step is carried out on the metal product by means of the plant.

If the respectively produced microstructure characterization does not meet the predetermined limit criterion step 24 is returned to according to the arrow 28. This procedure is continued until the respectively produced microstructure characterization meets the predetermined limit criterion.

### LIST OF REFERENCE NUMBERS

1 Partial view

2 Partial view

3 Partial view

4 Partial view

5 Partial view

6 Section

7 Curve

8 Section

9 Section

10 Section

11 System

12 Plant

13 Roller stand

14 Roller table

15 Shunt

16 Cooling section

17 Arrow

18 Recording device

19 Control and/or regulating device

20 Curve

21 Section

22 Curve

23 Section

24 Step

25 Step

26 Step

27 Processing step

28 Arrow

1-12. (canceled)

13. A method of controlling and/or regulating a metallurgical plant, comprising the steps of:
recording a metal microstructure of a metal product after carrying out a processing step on the metal product by the metallurgical plant;
producing at least one microstructure characterization that characterizes the respectively recorded metal microstructure;
comparing the respectively produced microstructure characterization with at least one predetermined limit criterion; and
carrying out a further processing step following the processing step on the metal product by means of the metallurgical plant only if the respectively produced microstructure characterization meets the predetermined limit criterion.

14. The method according to claim 13, wherein the recording of the metal microstructure takes place continuously or at predetermined time intervals until the respectively produced microstructure characterization meets the predetermined limit criterion.

15. The method according to claim 13, wherein the recording of the metal microstructure takes place using ultrasound.

16. The method according to claim 13, includes recording at least one further parameter of the metal product.

17. A computer program with program code means stored on a computer-readable data carrier which cause a computer or a corresponding calculation unit to implement a method according to claim 13 when run on the computer or the corresponding calculation unit.

18. A data carrier with a computer program according to claim 17.

19. A computer system on which a computer program according to claim 17 is loaded.

20. A system for controlling and/or regulating a metallurgical plant, comprising:
at least one recording device for recording a metal microstructure of a metal product after carrying out a processing step on the metal product by the metallurgical plant and
at least one control and/or regulating device, connectable in communication terms to the recording device, for producing at least one microstructure characterization that characterizes the respectively recorded metal microstructure,
wherein the control and/or regulating device is set up to compare the respectively produced microstructure characterization with at least one predetermined limit criterion; and
wherein the control and/or regulating device is set up to control and/or regulate the plant so that a further processing step following the processing step is carried out on the metal product by the metallurgical plant only if the respectively produced microstructure characterization meets the predetermined limit criterion.

21. The system according to claim 20, wherein the recording device and the control and/or regulating device are set up to carry out the recording of the metal microstructure continuously or at predetermined time intervals until the respectively produced microstructure characterization meets the predetermined limit criterion.

22. The system according to claim 20, wherein the recording device comprises at least one ultrasound sensor.

23. The system according to claim 22, wherein the ultrasound sensor an electromagnetic ultrasound sensor.

24. The system according to claim 23, wherein the recording device is set up to implement a laser-ultrasound method.

25. The system according to claim 20, further comprising at least one sensor unit, connectable in communication terms to the control and/or regulating device, for recording at least one further parameter of the metal product.
